(19) United States
(12) Patent Application Publication
(10) Pub. No.: US 2022/0354624 A1
(43) Pub. Date: Nov. 10, 2022

(54) METHOD OF MACHINING A DENTAL BLOCK FOR MANUFACTURING A DENTAL RESTORATION

(71) Applicants: DENTSPLY SIRONA Inc., York, PA (US); SIRONA Dental Systems GmbH, Bensheim (DE)

(72) Inventors: Franz BASLER, Laudenbach (DE); Oliver NOWARRA, Leimen (DE); Daniel WEISS, Heddesheim (DE)

(73) Assignee: DENTSPLY SIRONA Inc., York, PA (US)

(21) Appl. No.: 17/762,122

(22) PCT Filed: Oct. 8, 2020
(86) PCT No.: PCT/EP2020/078288

§ 371 Date: Mar. 21, 2022

(30) Foreign Application Priority Data
Oct. 8, 2019 (EP) 19202011.3

(51) Int. Cl. A61C 13/00; A61C 5/77

(52) U.S. Cl. CPC A61C 13/0006; A61C 5/77; A61C 13/0004; A61C 13/0022

(57) ABSTRACT

A method of machining a dental block (2) by using at least one dental tool (4) to finish or pre-finish a dental restoration (5) at least completely along the equator (5a) with or without a holding stub (5b). The method includes: a step of moving the axis (4a) of the dental tool (4) along a path (6) with an overlaid lateral motion having an amplitude (A), and without separating an unmachined piece (2″) from the rest of the dental block (2). The path (6) lies away from the equator (5a) at least by an amount equal to half of the diameter of the dental tool (4) plus half of the amplitude (A) of the overlaid lateral motion.

### TECHNICAL FIELD OF THE INVENTION

The present invention relates to a method of machining a dental block for manufacturing a dental restoration. The present invention more particularly relates to a dental machining system for machining a dental block.

### BACKGROUND ART OF THE INVENTION

In general, a dental machining system has a dental tool machine for machining a dental block which is typically made from ceramic. The dental tool machine generally comprises: one or more carriage units each movably holding at least one dental tool for machining a corresponding side of the dental block; a holding unit for holding the dental block relatively movably with respect to the dental tools; and a control unit for controlling the units. Generally, a CAD/CAM software is used to digitally construct a dental restoration and to provide the corresponding machining data to the dental tool machine. The CAD/CAM software is usually run on a processing unit such as a PC in the dental machining system. During the manufacturing of the dental restoration, the dental block is generally machined by using at least one dental tool to finish or pre-finish the dental restoration completely along the equator with a holding stub. Thereafter the upper and lower surfaces of the dental restoration are finished or pre-finished.

FIG. 3 shows a commonly used machining path (i.e., the meandering line) known from the prior art for machining the equator (5a) of a dental restoration (5) from a dental block (2).

The dashed lines inside the dental block (2) illustrate the dental restoration (5). The dental restoration (5) is connected to the rest of the block dental block (2) through a holding stub (5b). According to the prior art machining method illustrated in FIG. 3, the material is machined starting from the outside of the dental block (2) up to the dental restoration (5) with a low lateral infeed (typically 0.05 mm). In general, the machining time depends on the dental block size and dental restoration size. The machining time for a molar crown from a C14 dental block is approximately 10 minutes.

FIG. 4 shows another commonly used machining path (i.e., the bold line) known from the prior art for machining the equator (5a) of the dental restoration (5) from the dental block (2). According to the prior art machining method illustrated in FIG. 4, a channel (2b) is machined around the equator (5a) of the dental restoration (5) to cut out the rest of the dental block (2) from the dental restoration (5). The unmachined pieces (2′) of the dental block (2) drop down. Through this alternative prior art machining method, the machining time can be comparatively reduced. However, the unmachined pieces (2′) pose a risk of damaging the dental restoration (5) during the machining. Such a machining method is disclosed in EP3199124B1.

All the above-mentioned prior art machining methods can be performed in the practice of a dental professional during the presence of the patient. Therefore, the overall time spend for manufacturing the dental restoration is a critical factor. Long waiting periods are uncomfortable for the patients and increase the manufacturing costs.

### DISCLOSURE OF THE INVENTION

An objective of the present invention is to overcome the disadvantages of the prior art and provide a method of machining a dental block by using at least one dental tool to finish or pre-finish a dental restoration at least completely along the equator, with or without a holding stub.

This objective has been achieved through the machining method as defined in claim 1, and the dental machining system as defined in claim 12. The subject-matters of the dependent claims relate to further developments.

The present invention provides a method of machining a dental block by using at least one dental tool to finish or pre-finish a dental restoration at least completely along the equator, with or without a holding stub. The method comprises a step of moving the axis of the dental tool along a path with an overlaid lateral motion having an amplitude, and without separating an unmachined piece from the rest of the dental block, wherein the path lies away from the equator at least by an amount equal to half of the diameter of the dental tool plus half of the amplitude of the overlaid lateral motion.

A major advantageous effect of the present invention is that the machining time can be comparatively shortened. Thereby, the manufacturing costs can be reduced. Another major advantageous effect of the present invention is that the life time of the dental tool can be prolonged, and thus the dental restoration can be finished or pre-finished with a comparatively higher quality. Another major advantageous effect of the present invention is that the risk of damaging the dental restoration and/or the dental tool can be avoided or reduced as much as possible.

According to the present invention, the machining of the dental block may be carried out either in a single machining step or in multiple machining steps to finish or pre-finish the dental restoration at least completely around the equator, with or without a holding stub.

According to an embodiment of the present invention, the dental tool is moved at most one revolution around the equator of the dental restoration during the single machining step. During the revolution, the amplitude of the overlaid lateral motion is varied along the path according to the shape and size of the dental restoration to machine the entire rest of the dental block around the equator of the dental restoration and, thereby, to completely remove the rest of the dental block preferably except the holding stub in the single machining step. Thereby, the formation of any channel in the rest of the dental block and the separation of any unmachined piece from the rest of the dental block can be prevented. Thereby, the machining time can be significantly reduced and the risk of damaging the dental restoration can be avoided or reduced as much as possible.

According to another embodiment of the present invention, the dental tool is moved more than one revolution around the equator of the dental restoration during the multiple machining steps. During the revolutions, the amplitude of the overlaid lateral motion may be kept constant or varied along the path according to the shape and size of the dental restoration to machine, in each machining step, at least part of the rest of the dental block around the equator of the dental restoration and, thereby, to remove the rest of the dental block preferably except the holding stub successively in multiple machining steps. Thereby, the formation of a channel in the rest of the dental block and the separation of any unmachined piece from the rest of the dental block can be prevented. The number of the machining steps, namely the number of revolutions may be determined based on the desired machining time and the target geometry of the dental restoration. The number of revolutions may be an integer number or a fractional number. Thereby, the machining time can be further reduced and the risk of damaging the dental restoration can be avoided or reduced as much as possible.

According to the present invention, the shape of the dental tool path is determined by the movement of the central position of the dental tool axis and the amplitude of the overlaid motion of the dental tool axis. The central position of the dental tool axis preferably follows the shape of the equator of the dental restoration or the shape of the dental block.

The amplitude of the overlaid lateral motion that machines at least part of the rest of the dental block in the lateral direction with respect to the equator can be kept constant or varied such that the path has an oscillating shape, preferably a trochoidale shape. The longitudinal speed of the central position of the dental tool axis may be substantially constant or variable to vary the shape of the path. The transverse speed of the lateral movement may also be substantially constant or variable to vary the shape of the path.

According to the present invention, the machining method can be carried out by a single-spindle dental tool machine or alternatively by a multi-spindle dental tool machine, preferably by a double-spindle dental tool machine. Thereby the dental block can be simultaneously machined from at least two different sides, preferably opposite sides.

According to an embodiment of the present invention, the double-spindle dental tool machine has at least two dental tools for machining the dental block. The axes of the two dental tools are aligned parallelly in opposite direction and moved either simultaneously or sequentially along the corresponding paths to finish or pre-finish the dental restoration at least completely along the equator, with or without a holding stub.

According to the present invention, the dental block is preferably machined with the lateral surface of a dental tool along the equator. The length of the dental tool and the size of the dental block may vary. In an embodiment of the present invention, the axis of the dental tool is penetrated through the entire dental block. Alternatively, the axis of the dental tool is penetrated only in a part of the dental block. The dental block can be machined sequentially or simultaneously from two different sides by two different dental tools. Alternatively, the dental block can be rotated relative to the dental tool, and thus can be machined also from the other side by the same dental tool.

According to the present invention, various dental tools suitable for machining the dental block may be used. The dental tool may be a cylindrical shaped tool with or without a corner radius, a spherical shaped tool, a torical shaped tool, a conical shaped tool, a milling tool with defined cutting edges, or a grinding tool with undefined cutting edges or a tool having a combined shape of one or more of the preceding tools.

According to the present invention, the dental block may be produced from various materials and in various sizes suitable for manufacturing one or more dental restorations.

The dental block may be made of ceramic, pre-sintered ceramic, metal, pre-sintered metal, plastic, or a composite.

The present invention also provides a computer-program such as a CAD/CAM software comprising computer-executable codes for causing a computer-based dental machining system to carry out the method steps of the present invention. The present invention also provides a computer-readable data storage which stores the computer-program. The data storage may be internal or external to the dental machining system.

The present invention also provides a computer-based dental machining system having a single-spindle dental tool machine, or preferably a multi-spindle dental tool machine, more preferably a double-spindle dental tool machine. For instance, the double-spindle dental tool machine may have two tool spindles each having three degrees of freedom or alternatively two degrees of freedom with a kinematic axis coupling for the relatively movable dental blank. According to an embodiment, the dental machining system comprises a double-spindle dental tool machine which comprises: one or more carriage units each movably holding at least one dental tool for machining a corresponding side of the dental block; a holding unit for holding at least one dental block relatively movably with respect to the dental tools; and a control unit adapted to individually control drive of the carriage units and the holding unit according to the machining method of the present invention. The path of each dental tool is determined by the computer program such as the CAD/CAM software run on a processing unit or a PC in the dental machining system according to the machining method of the present invention.

### BRIEF DESCRIPTION OF THE DRAWINGS

In the subsequent description, further aspects and advantageous effects of the present invention will be described in more detail by using exemplary embodiments and by reference to the drawings, wherein

FIG. 1—is a dental block according to an embodiment of the present invention, wherein the dashed lines show a dental restoration to be machined from the dental block with the dental tool machine in FIG. 9;

FIG. 2—is the dental restoration machined from the dental block of FIG. 1 through a method according to an embodiment of the present invention;

FIG. 3—is a schematic view of a machining path (i.e., the meandering line) according to the prior art for machining the equator of a dental restoration (dashed lines) from a dental block;

FIG. 4—is a schematic view of another machining path (i.e., the bold line) according to the prior art for machining the equator of a dental restoration (dashed lines) from a dental block;

FIG. 5—is a schematic view of a machining method according to a first embodiment of the present invention for machining the dental block along the equator of the dental restoration (dashed lines) in a single machining step, wherein the arrows show the varying amplitude of the overlaid lateral motion of the dental tool axis;

FIG. 6 to FIG. 8—are schematic views of another machining method according to a second embodiment of the present invention for machining the dental block along the equator of the dental restoration (dashed lines) in two machining steps, wherein the arrows show the substantially constant amplitude of the overlaid lateral motion of the dental tool axis;

FIG. 9—is a partial perspective view of a dental machining system according to an embodiment of the present invention for machining the dental block of FIG. 1.

The reference numbers shown in the drawings denote the elements as listed below and will be referred to in the subsequent description of the exemplary embodiments:
1. Dental tool machine
2. Dental block
   2′ Corner piece
   2a. Shaft
   2b. Channel
3. Carriage unit
   3a. Arm
   3b. Shaft
4. Dental tool
   4a. Axis
5. Dental restoration
   5a. Equator
   5b. Stub
6. Path

A: Amplitude of the overlaid lateral motion

FIG. 9 illustrates part of a dental machining system according to an embodiment of the present invention. The dental machining system has a double-spindle dental tool machine (1). The dental tool machine (1) has two carriage units (3) each movably holding a dental tool (4) for machining a corresponding side of the dental block (2); a holding unit (not shown) for holding a dental block (2) relatively movably with respect to the dental tools (4); and a control unit adapted to individually control drive of the carriage units (3) and the holding unit according to the machining method of the present invention. The machining method will be described later in the subsequent description. Each carriage unit (3) has an arm (3a) which is connected to a respective shaft (3b). Each shaft (3b) can be rotated around the z-axis and translated along the z-axis by means of a respective driving mechanism (not shown) of the carriage unit (3). The axes (4a) of the two dental tools (4) are aligned parallelly in opposite directions (z). Each dental tool (4) is mountable to a respective tool motor (not shown) in the respective arm (3a). The dental tool (4) may be one of a cylindrical shaped tool (4) with or without a corner radius, a spherical shaped tool (4), a torical shaped tool (4), a conical shaped tool (4), a milling tool (4) with defined cutting edges, or a grinding tool (4) with undefined cutting edges or a tool (4) having a combined shape of one or more of the preceding tools (4). The dental block (2) is connected via the holding unit to a shaft (2a). The dental block (2) may be made of a material which includes ceramic, pre-sintered ceramic, metal, pre-sintered metal, plastic, or a composite. The shaft (2a) for the dental block (2) can be rotated around the y-axis and translated along the y-axis by means of a respective driving mechanism (not shown).

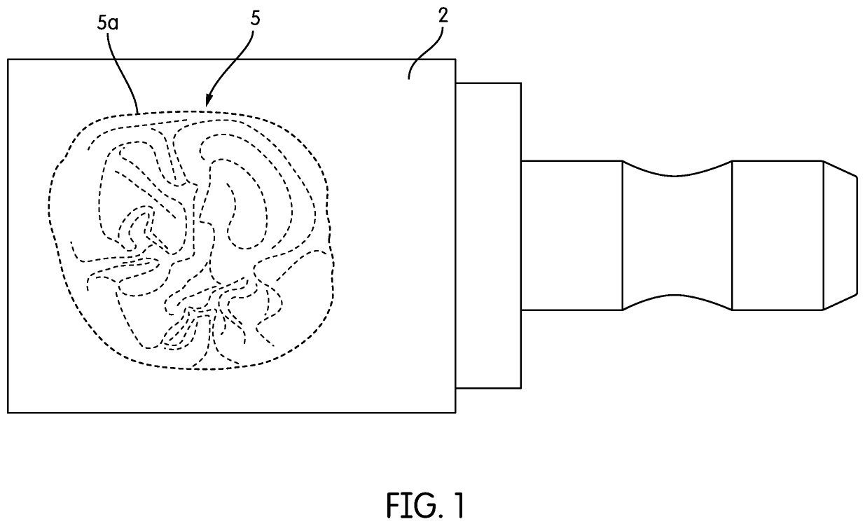

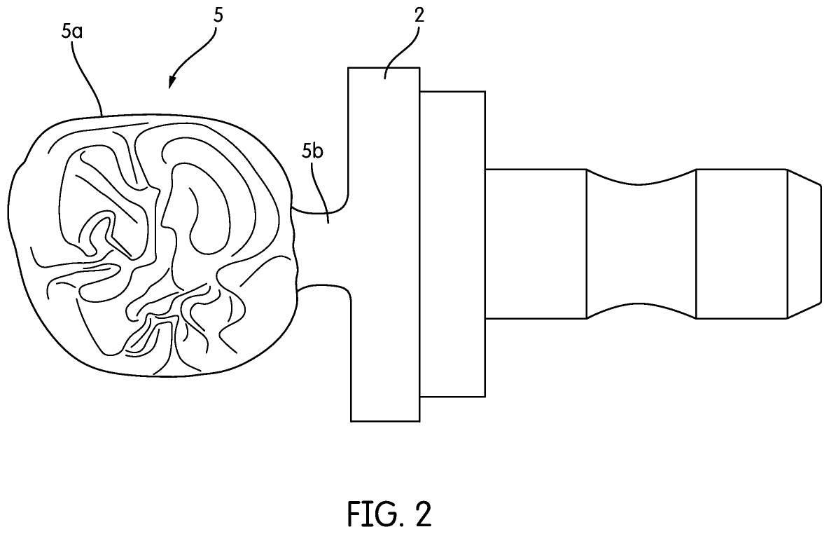

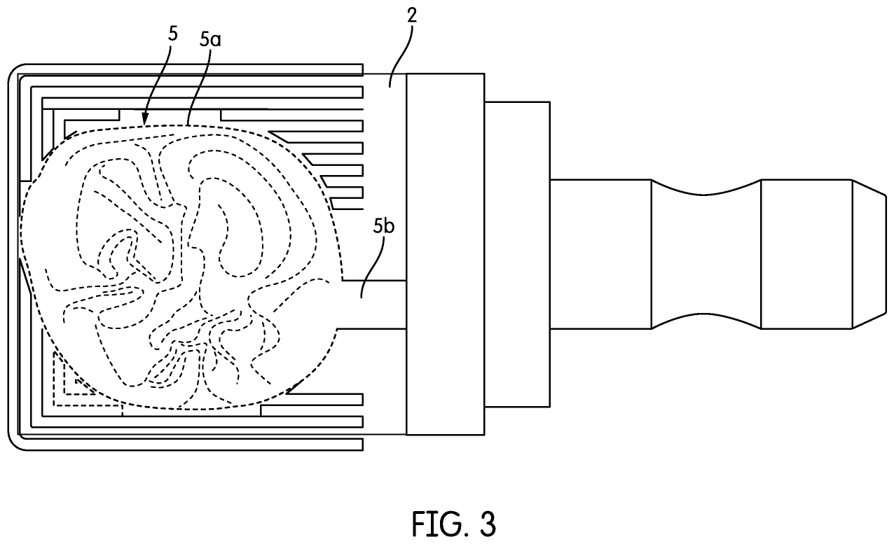

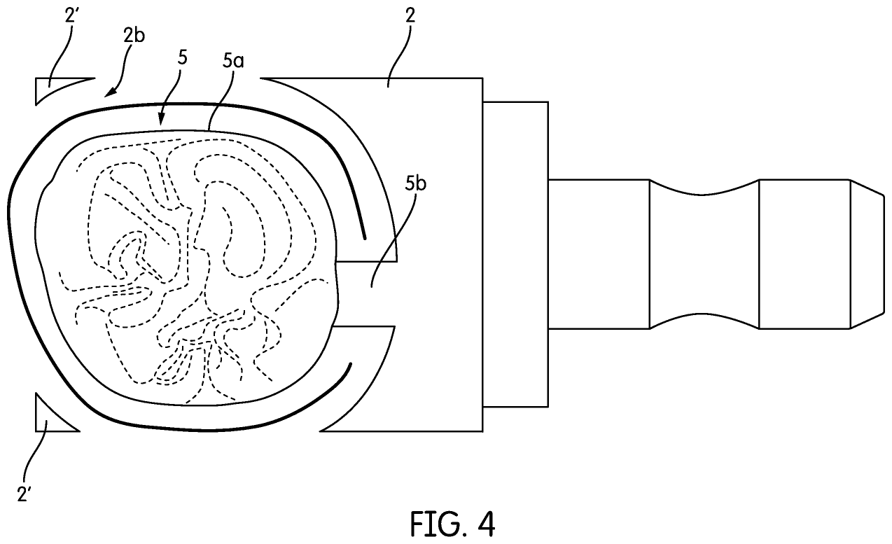

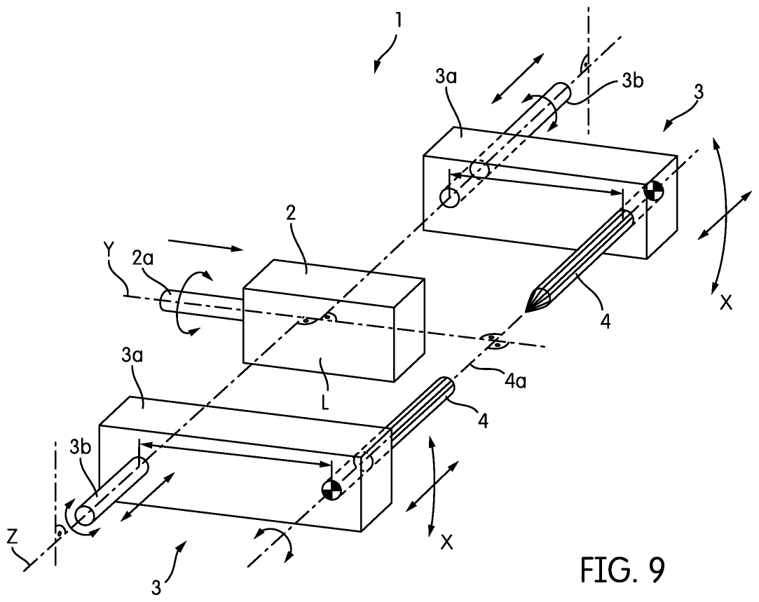

FIG. 1 shows an enlarged view of a dental block (2) according to an embodiment of the present invention. The dental block (2) may be rectangular shaped or alternatively round shaped. The dashed lines in FIG. 1, illustrate a dental restoration (5) to be machined from the dental block (2) with the dental tool machine (1) in FIG. 9. FIG. 2 shows the enlarged view of the dental restoration (5) machined from the dental block (2) in FIG. 1 through the machining method according to an embodiment of the present invention. In the method of machining the dental block (2), at least one dental tool (4) is used to finish or pre-finish the dental restoration (5), at least completely along the equator (5a), with or without a holding stub (5b).

According to the present invention, the machining of the dental block (2) may be carried out either in a single machining step or in multiple machining steps to finish or pre-finish the dental restoration (5) at least completely around the equator (5a), with or without a holding stub (5b).

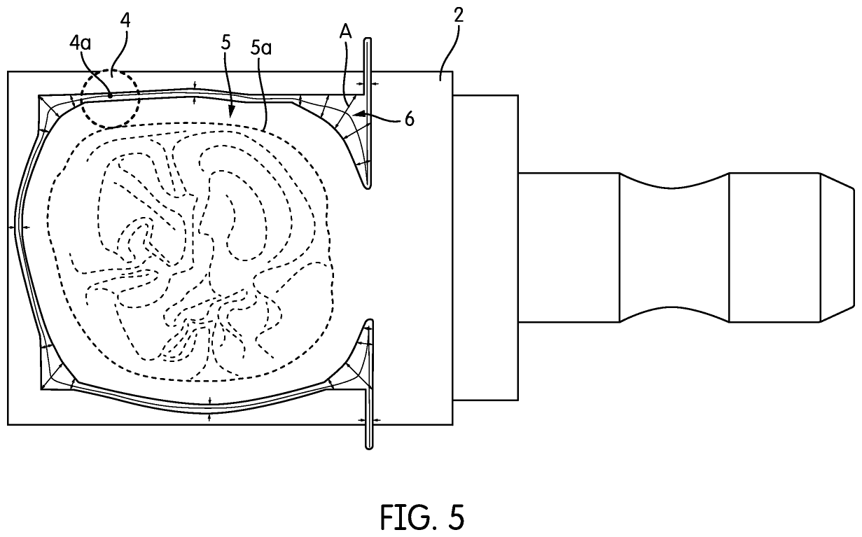

FIG. 5 illustrates the machining method according to a first embodiment of the present invention in which a single machining step is carried out. As shown in FIG. 5, the axis (4a) of the dental tool (4) is moved along a path (6) with an overlaid lateral motion having an amplitude (A), and without separating an unmachined piece (2′) from the rest of the dental block (2). The path (6) lies away from the equator (5a) by an amount equal to half of the diameter of the dental tool (4) plus half of the amplitude (A) of the overlaid lateral motion. The amplitude (A) is varied along the path (6) such that the rest of the dental block (2) around the equator (5a) of the dental restoration (5) is completely removed except for the holding stub (5b). FIG. 2 shows the dental block (2) after the single machining step is completed.

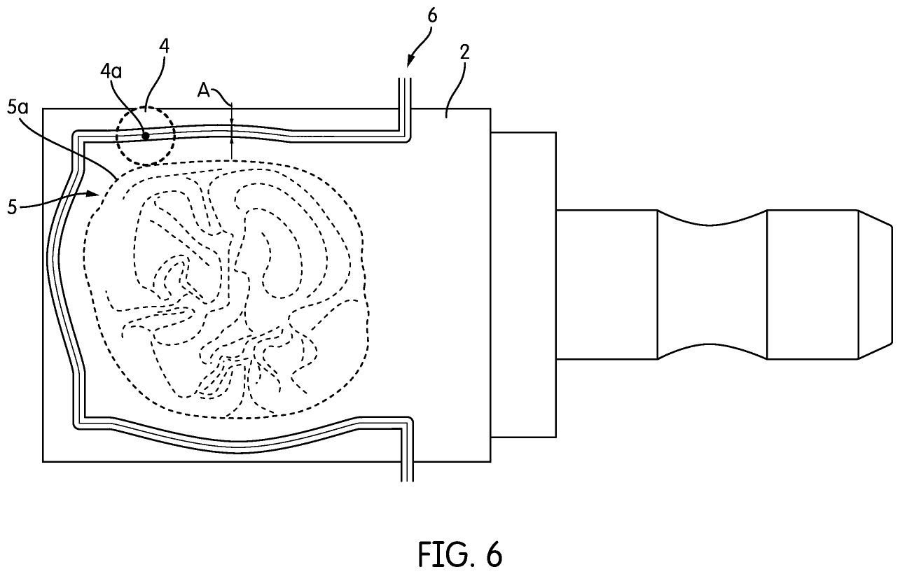

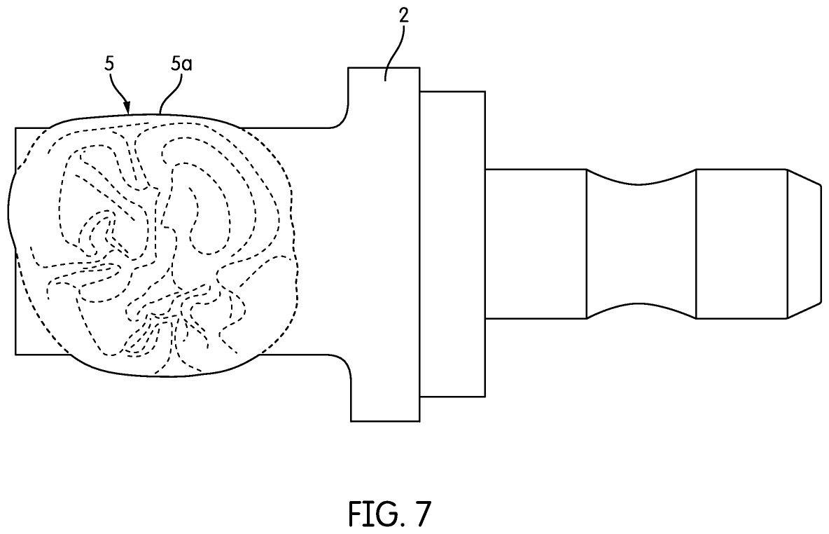

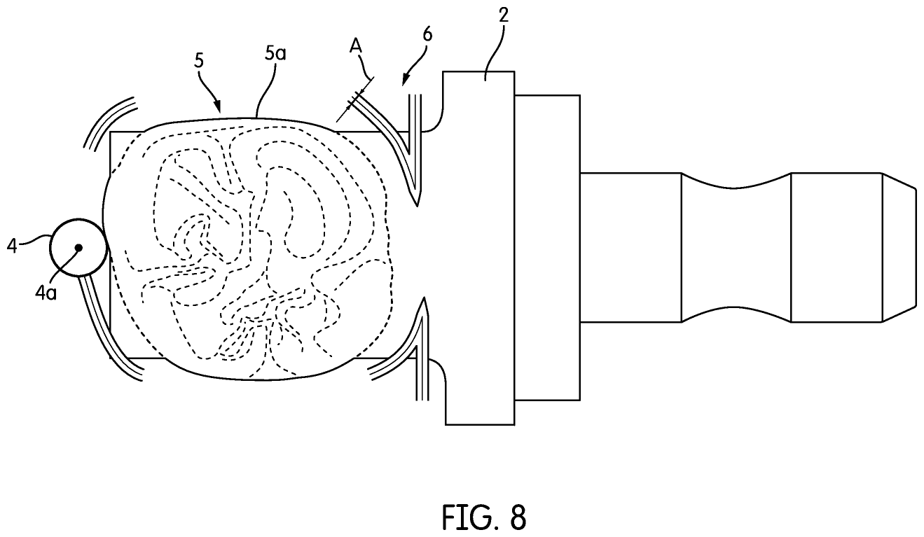

For ease of description, the multi-step machining will be explained for the case where two machining steps are carried out sequentially. FIG. 6 to FIG. 8 illustrate the machining method according to a second embodiment of the present invention in which two machining steps are sequentially carried out. FIG. 6 shows the first machining step. As shown in FIG. 6, the axis (4a) of the dental tool (4) is moved along a path (6) with an overlaid lateral motion having an amplitude (A), without separating an unmachined piece (2′) from the rest of the dental block (2). The path (6) lies away from the equator (5a) at least by an amount equal to half of the diameter of the dental tool (4) plus half of the amplitude (A) of the overlaid lateral motion. The amplitude (A) is kept substantially constant along the path (6). FIG. 7 shows the dental block (2) after the first machining step is completed. As shown in FIG. 7, the rest of the dental block (2) around the equator (5a) of the dental restoration (5) is completely removed only in three sections of the dental block (2). FIG. 8 shows the second machining step. As shown in FIG. 8, the axis (4a) of the dental tool (4) is moved along a path (6) with the same overlaid lateral motion having the amplitude (A), without separating an unmachined piece (2′) from the rest of the dental block (2). The path (6) lies away from the equator (5a) at least by an amount equal to half of the diameter of the dental tool (4) plus half of the amplitude (A) of the overlaid lateral motion. The amplitude (A) is kept substantially constant along the path (6). FIG. 2 shows the dental block (2) after the second machining step is completed. As shown in FIG. 2, after the second machining step, the rest of the dental block (2) around the equator (5a) of the dental restoration (5) becomes completely removed except for the holding stub (5b).

1. A computer-implemented method comprising: machining a dental block by using at least one dental toot to finish or pre-finish a dental restoration at least completely along an equator, with or without a holding stub, the method further comprising a step of
moving an axis of the dental tool along a path with an overlaid lateral motion having an amplitude (A), and without separating an unmachined piece from a rest of the dental block, wherein the path lies away from the equator at least by an amount equal to half of the diameter of the dental tool plus half of the amplitude (A) of the overlaid lateral motion.

2. The method according to claim 1, further comprising:
moving dental tool at most one revolution around the equator to finish or pre-finish the dental restoration at least completely along the equator, with or without a holding stub.

3. The method according to claim 1, further comprising:
moving the dental tool more than one revolution around the equator to finish or pre-finish the dental restoration at least completely along the equator, with or without a holding stub.

4. The method according to claim 1, wherein the amplitude (A) of the overlaid lateral motion is kept constant or varied along the path.

5. The method according to claim wherein the path has a trochoidal shape.

6. The method according to claim 1, wherein two dental tools are used for machining the dental block, wherein the axes, of the two dental tools are aligned parallelly m opposite direction (z) and moved either simultaneously or sequentially along the corresponding paths to finish or pre-finish the dental restoration at least completely along the equator, with or without a holding stub.

7. The method according to claim wherein the lateral surface of at least one dental tool is used for machining the dental block, wherein the axis of the dental tool is penetrated through the entire dental block, or only in a part of the dental block.

8. The method according to claim 1, wherein each dental tool is one of a cylindrical shaped tool with or without a corner radius, a spherical shaped tool, a torical shaped tool, a conical shaped tool, a milling tool with defined cutting edges, or a grinding tool with undefined cutting edges or a tool haying a combined shape of one or more of the preceding tools.

9. The method according to claim 1, wherein the dental block is made of a material comprising ceramic, pre-sintered ceramic, metal, pre-sintered metal, plastic, and/or a composite.

10. A computer-program comprising computer-readable codes for causing a computer-based dental machine system to execute the method steps according to claim 1.

11. A non-transitory computer-readable storage medium storing a program which when executed by a computer system causes the computer system to perform the method steps as defined in claim 1.

12. A dental machining system comprising:
a dental tool machine which comprises:
one or more carriage units each configured to movably hold at least one dental tool for machining a corresponding side of the dental block;
a holding unit configured to hold at least one dental block relatively movably with respect to the dental tools; and
a control unit having a computer-program configured to individually control drive of the carriage units and the holding unit according to the method defined in claim 1.
